(19) United States
(12) Patent Application Publication
(10) Pub. No.: US 2022/0385433 A1
(43) Pub. Date: Dec. 1, 2022

(54) RADIOFREQUENCY SENSING DURING INTERFRAME SPACING IN A WI-FI SYSTEM

(71) Applicant: Nokia Technologies Oy, ESpoo (FI)

(72) Inventors: Enrico RANTALA, Berkeley, CA (US); Klaus DOPPLER, Albany, CA (US)

(73) Assignee: Nokia Technologies Oy, Espoo (FI)

(21) Appl. No.: 17/754,130

(22) PCT Filed: Sep. 24, 2019
(86) PCT No.: PCT/US2019/052739

§ 371 Date: Mar. 24, 2022

(51) Int. Cl. H04L 5/00; H04L 27/00; H04W 74/08; H04J 13/00

(52) U.S. Cl. CPC H04L 5/0055; H04L 27/0006; H04W 74/0808; H04L 5/0007; H04J 13/0029; H04J 13/0062

(57) ABSTRACT

A wireless node, such as an access point or a user equipment, includes a transceiver configured to transmit during a first frame in a first time interval and a second frame in a second time interval. The first and second time intervals are separated by an interframe space (IFS). The wireless node also includes a processor configured to generate a sensing waveform. The transceiver transmits the sensing waveform during the IFS. In some cases, the processor is configured to switch the transceiver from a transmit mode during the first time interval to a receive mode during the IFS. The transceiver receives a sensing waveform from a wireless node during the IFS.

### BACKGROUND

Wireless communication systems include access points that provide wireless connectivity according to the Wi-Fi standards, which are a subset of the IEEE 802 family of standards. For example, the medium access control (MAC) and physical layer (PHY) specifications for Wi-Fi access points are defined by IEEE 802.11 for transmitting and receiving data in frequency bands such as infrared, 2.4 gigahertz (GHz), 3.6 GHz, 5 GHz, 60 GHz, and the like. Wi-Fi signals are used to perform radiofrequency sensing of an environment between Wi-Fi access points and a user equipment. For example, Wi-Fi sensing can potentially be used to determine presence or measure a range, angle, or velocity of objects including people. Radiofrequency sensing is a passive sensing technique because the objects or people are not required to include any specialized electronic equipment in order to be sensed. Examples of potential use cases for Wi-Fi sensing include monitoring the health or activity of people within a home, detecting intruders, energy management, emotion recognition, interactive game control, automatic adjustment of appliances based on user location, and the like. However, the bandwidth available for transmission and reception of Wi-Fi signals is primarily used to data communications. Users are unlikely to sacrifice bandwidth or transmission speed to implement monitoring applications.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, an apparatus is provided. Some embodiments of the apparatus include a transceiver configured to transmit during a first frame in a first time interval and a second frame in a second time interval, wherein the first and second time intervals are separated by an interframe space (IFS) and a processor configured to generate a sensing waveform, wherein the transceiver transmits the sensing waveform during the IFS.

In some embodiments, the IFS has a duration sufficient to receive a last symbol of the first frame, process the first frame, and respond with a first symbol of an earliest possible response frame.

In some embodiments, the sensing waveform is at least one of an orthogonal frequency division multiplexing (OFDM) signal, a W-Fi training sequence, a Zadoff Chu sequence, and a Gold Code.

Some embodiments of the transceiver are configured to transmit the sensing waveform after a transition time interval at the beginning of the IFS, wherein the transition time interval has a duration sufficient to allow the transceiver to transition from a transmit mode to a receive mode.

Some embodiments of the transceiver are configured to transmit a request for a measurement signal from a wireless node; receive, at a first reception time, the measurement signal from the wireless node in response to the request; transmit, at a first transmission time, an acknowledgment signal in response to receiving the measurement signal; and receive a result signal in response to the acknowledgment signal. The result signal includes information indicating a second transmission time of the measurement signal and a second reception time of the acknowledgment signal.

Some embodiments of the processor are configured to determine a round-trip time between the apparatus and the wireless node based on the first and second reception times and the first and second transmission times.

Some embodiments of the transceiver are configured to transmit the sensing waveform during the IFS in response to instructions received from a controller.

Some embodiments of the transceiver are configured to determine a transmission power for the sensing waveform based on topology information for other wireless nodes.

In some embodiments, an apparatus is provided. The apparatus includes a transceiver configured to transmit during a first frame in a first time interval and a second frame in a second time interval. The first and second time intervals are separated by an interframe space (IFS). The apparatus also includes a processor configured to switch the transceiver from a transmit mode during the first time interval to a receive mode during the IFS. The transceiver receives a sensing waveform from a wireless node during the IFS.

In some embodiments, the IFS has a duration sufficient to receive a last symbol of the first frame, process the first frame, and respond with a first symbol of an earliest possible response frame.

In some embodiments, the sensing waveform is at least one of an orthogonal Frequency division multiplexing (OFDM) signal, a W-Fi training sequence, a Zadoff Chu sequence, and a Gold Code.

Some embodiments of the transceiver are configured to switch from the transmit mode to the receive mode during a transition time interval at the beginning of the IFS.

Some embodiments of the transceiver are configured to receive a request for a measurement signal from a wireless node; transmit, at a transmission time, the measurement signal from the wireless node in response to the request; receive, at a reception time, an acknowledgment signal in response to transmitting the measurement signal; and transmit a result signal in response to the acknowledgment signal. The result signal includes information indicating the transmission time and the reception time.

Some embodiments of the processor are configured to switch the transceiver from the transmit mode to the receive mode in response to instructions received from a controller.

Some embodiments of the processor are configured to determine at least one of presence of an object or person, a range of the object or person, an angle of the object or person, and a velocity of the object or person.

Some embodiments of the processor are configured to transmit information representative of the received sensing waveform to a controller, which uses the transmitted information to determine at least one of presence of an object or person, a range of the object or person, an angle of the object or person, and a velocity of the object or person.

In some embodiments, an apparatus is provided. The apparatus includes a transceiver configured to exchange signals with a plurality of wireless nodes that are configured transmit or receive in frames during time intervals. The time intervals are separated by an interframe space (IFS). The apparatus also includes a processor configured to select a first subset of the plurality of wireless nodes to operate in a transmit mode during the IFS and a second subset of the plurality of wireless nodes to operate in a receive mode during the IFS. The first subset transmits a sensing waveform during the IFS.

In some embodiments, the IFS has a duration sufficient to receive a last symbol of the first frame, process the first frame, and respond with a first symbol of an earliest possible response frame.

In some embodiments, the sensing waveform is at least one of an orthogonal Frequency division multiplexing (OFDM) signal, a W-Fi training sequence, a Zadoff Chu sequence, and a Gold Code.

Some embodiments of the transceiver are configured to transmit the sensing waveform after a transition time interval at the beginning of the IFS, wherein the transition time interval has a duration sufficient to allow the transceiver to transition from a transmit mode to a receive mode.

Some embodiments of the transceiver are configured to instruct at least one of the plurality of wireless nodes to switch from a transmit mode to a receive mode or from a receive mode to a transmit mode.

Some embodiments of the processor are configured to modify members of the first subset and the second subset in a subsequent IFS.

Some embodiments of the processor are configured to perform at least one of randomly assigning the plurality of wireless nodes to the first subset or the second subset or using a round-robin scheduling technique to assign the plurality of wireless nodes to the first subset or the second subset.

Some embodiments of the processor is configured to interrupt transmission of the sensing waveform during the subsequent IFS.

Some embodiments of the transceiver are configured to receive information representative of the sensing waveform received by the second subset, and wherein the processor is configured to determine at least one of presence of an object or person, a range of the object or person, an angle of the object or person, and a velocity of the object or person based on the received information.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a diagram of a communication system that performs radiofrequency sensing during interframe space (IFS) between frames transmitted by access points or user equipment according to some embodiments.

FIG. 2 is a block diagram of a communication system that is transmitting data in frames during a first time interval according to some embodiments.

FIG. 3 is a block diagram of a communication system that is transmitting a sensing waveform during an IFS following the first time interval according to some embodiments.

FIG. 4 is a block diagram of a communication system during a second time interval that includes data transmission to acknowledge signals transmitted during the first time interval according to some embodiments.

FIG. 5 is a block diagram of a communication system including user equipment that is transmitting a sensing waveform during an IFS following the second time interval according to some embodiments.

FIG. 6 is a block diagram of a communication system that includes a mesh of user equipment that perform radiofrequency sensing during an IFS according to some embodiments.

FIG. 7 is a timing diagram illustrating transmit and receive modes for access points and user equipment according to some embodiments.

FIG. 8 illustrates a message exchange that is used to determine a round trip time between an initiating node and a responding node according to some embodiments.

FIG. 9 is a flow diagram of a method of performing radiofrequency sensing using sensing waveforms transmitted during an IFS according to some embodiments.

FIG. 10 is a block diagram of a communication system that supports radiofrequency sensing during IFS according to some embodiments.

### DETAILED DESCRIPTION

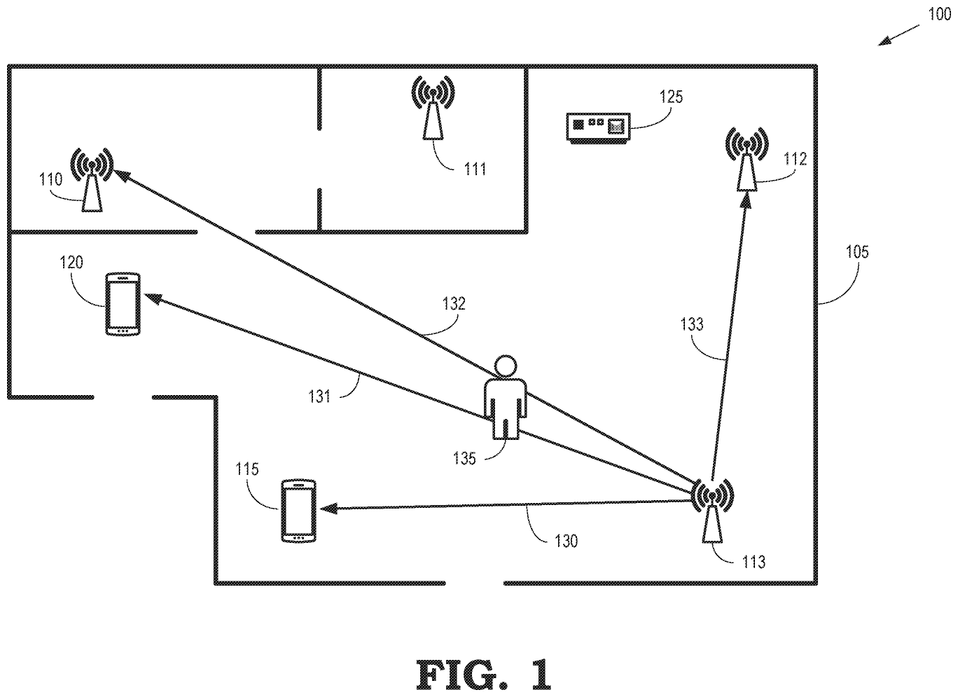

FIGS. 1-10 disclose embodiments of a system that supports in-band coexistence of data transmission and radiofrequency sensing in the same radio frequency spectrum by coordinating the operation of W-Fi access points to transmit and receive sensing waveforms during an interframe space (IFS) that separates consecutive frames transmitted by W-Fi access points. The frames can include data frames, management frames, and control frames, which can be transmitted in unicast messages, broadcast messages, or multicast messages. The 802.11 standards define an IFS as the nominal time (in microseconds, μs) that the medium access control (MAC) and physical layer (PHY) require in order to receive the last symbol of a frame, process the frame, and respond with the first symbol of the earliest possible response frame. In some embodiments, the IFS time interval has a duration of 16 microseconds (μs) and the transition time needed to switch from a transmit mode to a receive mode (or vice versa) may be on the order of 1 μs, which leaves sufficient time to transmit sensing waveforms such as 4 μs orthogonal frequency division multiplexing (OFDM) signals, a W-Fi training sequence, a Zadoff Chu sequence, a Gold Code, and the like. However, the IFS time interval and the transition time interval are longer or shorter in other embodiments. Although the term “radiofrequency sensing” is used to describe some embodiments of the sensing techniques disclosed herein, persons of ordinary skill in the art should appreciate that other embodiments of the sensing techniques utilize signals transmitted in other frequency bands.

In some embodiments, a controller (such as an access point or a dedicated server connected to access points) coordinates operation of a plurality of W-Fi access points. One or more of the W-Fi access points transmits data during a first time interval that is followed by an IFS time interval. After the first time interval, the controller instructs a first subset of the W-Fi access points to transmit a sensing waveform and a second subset of the W-Fi access points to receive the sensing waveform during the following IFS time interval. The second subset transition from a transmission mode to a reception mode during a transition time interval in the IFS time interval. After the transition time interval, the first subset of the W-Fi access points begins transmitting the sensing waveform, which is received by the second subset. The second subset transmits information that represents the received signals to the controller (which can be an access point). The controller then performs the sensing signal processing or provides the information to another entity that performs the sensing signal processing. The base station modifies the members of the first and second subsets in subsequent IFS time intervals, e.g., by randomly assigning W-Fi access points to the first or second subsets, using a round-robin scheduling technique, and the like. In some embodiments, a round trip time between two W-Fi access points is determined by exchanging sensing signals during the IFS time interval.

FIG. 1 is a diagram of a communication system 100 that performs radiofrequency sensing during interframe space (IFS) between frames transmitted by access points or user equipment according to some embodiments. The communication system 100 is implemented in an indoor space 105, although some embodiments of the communication system 100 are implemented in an outdoor space or an indoor/outdoor environment. The communication system 100 includes a set of access points 110, 111, 112, 113 (collectively referred to herein as “the access points 110-113”) that provide wireless connectivity to one or more user equipment 115, 120. The access points 110-113 and the user equipment 115, 120 are also referred to herein as “wireless nodes” because they are nodes in the communication system 100 that communicate wirelessly over an air interface. The access points 110-113 and the user equipment 115, 120 transmit or receive data in frames that are transmitted during time intervals that are reserved for transmission of data. The data transmission time intervals are separated by respective IFS time intervals to provide the wireless nodes with time to process the data and prepare an acknowledgement of the received data.

In the illustrated embodiment, a controller 125 (also referred to herein as a base station) coordinates operation of the access points 110-113. For example, the controller 125 can support multi-access point coordination including coordinated beamforming by two or more of the access points 110-113, joint processing of signals that are transmitted and received by a distributed antenna system that includes antennae associated with one or more of the access points 110-113, and the like. Transmission and reception in time, frequency, and phase are synchronized over some embodiments of the access points 110-113 and the user equipment 115, 120 to support coordination. In the interest of clarity, the wired or wireless connections between the controller 125 and the access points 110-113 are not shown in FIG. 1.

The access points 110-113, the user equipment 115, 120, and the controller 125 are configured to perform radiofrequency sensing, which is a non-intrusive technology that utilizes signals transmitted on radio frequencies to acquire local insights from the environment of the communication system 100. Examples of radiofrequency sensing include infrastructure-based channel state information (CSI) sensing that utilizes signals transmitted by the access points 110-113 or the user equipment 115, 120 such as W-Fi communication signals that allow reuse of the existing infrastructure. In the illustrated embodiment, the access point 113 transmits a sensing waveform that is received by the access points 110, 112 and the user equipment 115, 120, as indicated by the arrows 130, 131, 132, 133, which are collectively referred to herein as “the sensing waveforms 130-133.” The sensing waveforms 130-133 are formed as an orthogonal frequency division multiplexing (OFDM) signal, a Wi-Fi training sequence, a Zadoff Chu sequence, a Gold Code, or other signal type or format.

Transmission of the sensing waveforms 130-133 coexists with data transmissions in the same frequency bands by using the IFS to transmit the sensing waveforms 130-133 without interfering with data transmissions during time intervals for transmitting one or more frames. For example, one or more of the access points 110-113 or the user equipment 115, 120 can transmit sensing waveforms during a Short IFS (SIFS) that is used to separate frames in time to allow wireless nodes to prepare a response to any received frames. The SIFS is defined by the 802.11 standards as having a duration equal to a nominal time (in μs) that the MAC and PHY require in order to receive the last symbol of a frame, process the frame, and respond with the first symbol of the earliest possible response frame. In 802.11, the SIFS on the 5 gigahertz (GHz) frequency band is 16 μs and the SIFS on the 2.4 GHz frequency band is 10 μs.

The controller 125 selects one or more of the access points 110-113 or the user equipment 115, 120 to transmit a sensing waveform during an IFS. In some embodiments, the controller 125 instructs another controller (not shown in FIG. 1) to perform, or instruct associated access points or user equipment to perform, the sensing functions disclosed herein. The controller 125 provides signaling to the selected wireless node(s) to indicate that the wireless node(s) should be in a transmit mode during the IFS, either by remaining in a transmit mode or switching from a receive mode to the transmit mode. The controller 125 also provides signaling to the other wireless nodes that are not selected for transmission of the sensing waveform. The signaling indicates that the other wireless nodes should be in a receive mode during the IFS, either by remaining in the received mode or switching from the transmit mode to the receive mode. Switching between the transmit mode and the received mode occurs during a transition time interval at the beginning of the IFS, e.g., during the first x μs of the IFS where x may be on the order of 1 μs. In some embodiments, the wireless nodes that are selected for transmission determine a transmission power for the sensing signal based on topology information for other wireless nodes in the communication system 100.

Some embodiments of the controller 125 select different subsets of the access points 110-113 or the user equipment 115, 120 for transmission and reception of the sensing waveform during different IFS time intervals. For example, the controller 125 can assign the access points 110-113 or the user equipment 115, 120 to a first subset of wireless nodes that transmitted the sensing waveform during an IFS and a second subset that receive the sensing waveform during the IFS. The controller 125 can randomly assign the access points 110-113 or the user equipment 115, 120 to the first subset and the second subset, use a round-robin scheduling technique to assign the access points 110-113 or the user equipment 115, 120 to the first subset or the second subset, modify the assignment of the access points 110-113 or the user equipment 115, 120 to the first and second subset in response to an event, or use other selection techniques to establish or modify membership in the first and second subsets.

Wireless nodes that receive the sensing waveforms provide information representative of the received sensing waveform to the controller 125. In the illustrated embodiment, the access points 110, 112 and the user equipment 115, 120 provide information representative of the received sensing waveforms 130-132 to the controller 125. This information is used to generate information about the environment proximate the access points 110-113 and the user equipment 115, 120. In some embodiments, the controller 125 (or another entity connected to the controller 125, such as a local or cloud computing service) processes the information representative of the received sensing waveforms 130-132 to determine presence of an object or person such as the person 135, a range of the object or the person 135, an angle of the object or the person 135, and a velocity of the object or person 135.

In some embodiments, sensing waveforms transmitted during the IFS are used to determine a round trip time between two wireless nodes in the wireless communication system 100. The round trip time is determined based on messages exchanged during the IFS. For example, the access point 113 receives a request for a measurement signal from the access point 110. In response to receiving the request, the access point 113 transmits, at a transmission time, a measurement signal to the access point 110, which receives the measurement signal and generates an acknowledgment signal to indicate that it successfully received the measurement signal. The acknowledgment signal is transmitted to the access point 113 and the acknowledgment signal is received by the access point 113 that a reception time. In response to receiving the acknowledgment signal, the access point 113 transmits a result signal that includes information indicating the transmission time and the reception time. The access point 110 receives the result signal and uses the information in the result signal to determine the round trip time, as discussed below.

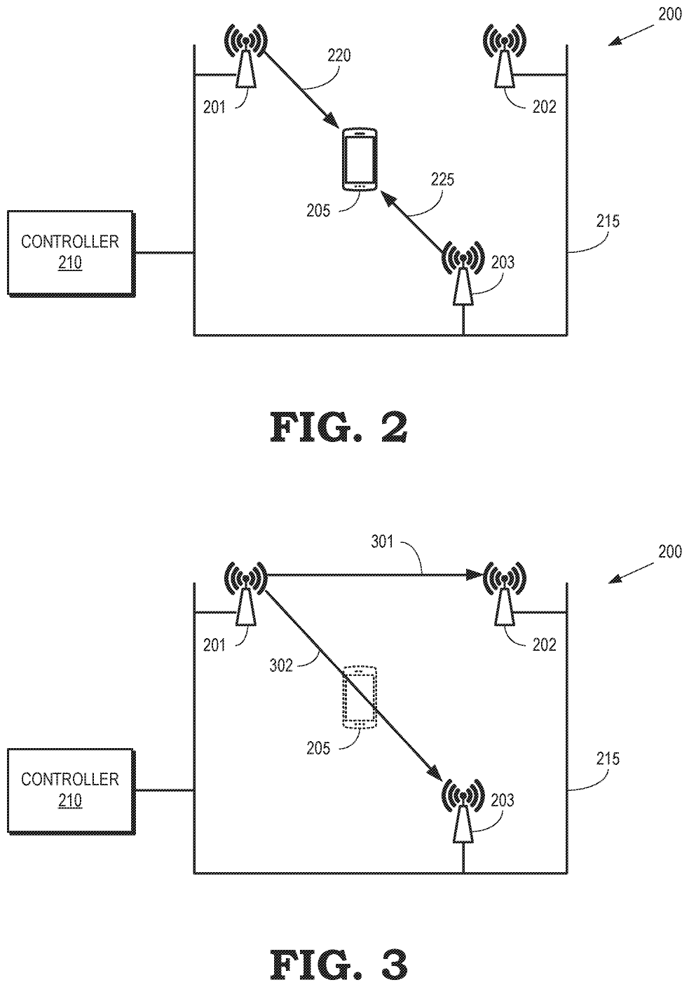

FIG. 2 is a block diagram of a communication system 200 that is transmitting data in frames during a first time interval according to some embodiments. In the illustrated embodiment, the communication system 200 includes access points 201, 202, 203 (collectively referred to herein as “the access points 201-203”), user equipment 205, and a controller 210. These entities are interconnected by a backbone 215. The communication system 200 is used to implement some embodiments of the communication system 100 shown in FIG. 1.

During the first time interval, the access points 201, 203 are transmitting downlink data signals to the user equipment 205, as indicated by the arrows 220, 225. The access point 202 is not scheduled for downlink data transmission during the first time interval. In some embodiments, the controller 210 schedules the downlink transmissions by the access points 201-203 and provides signals over the backbone 215 to the access points 201-203 indicating the scheduled downlink transmissions. The downlink data signals 220, 225 include data in frames that are transmitted during the first time interval.

FIG. 3 is a block diagram of the communication system 200 that is transmitting a sensing waveform during an IFS following the first time interval according to some embodiments. In the illustrated embodiment, the communication system 200 includes the access points 201-203, the user equipment 205, and the controller 210, which are interconnected by the backbone 215, as discussed with regard to FIG. 2.

The controller 210 transmits signals that cause the access point 201 to remain in the transmit mode and cause the access points 202, 203 to switch from the transmit mode to a receive mode during the IFS. The transition from the transmit mode to the receive mode takes place during a transition time interval at the beginning of the IFS. Following the transition time interval, the access point 201 transmits a sensing waveform to the access points 202, 203, as indicated by the arrows 301, 302. The access points 202, 203 receive the sensing waveforms 301, 302 and provide information representative of the received sensing waveforms to the controller 210 via the backbone 215. As discussed herein, the information received by the controller 210 is used to generate information representative of the environment of the communication system 200. In the illustrated embodiment, the user equipment 205 does not participate in the radiofrequency sensing, as indicated by the dotted outline. However, in other embodiments, the user equipment 205 participate in receiving the sensing waveforms.

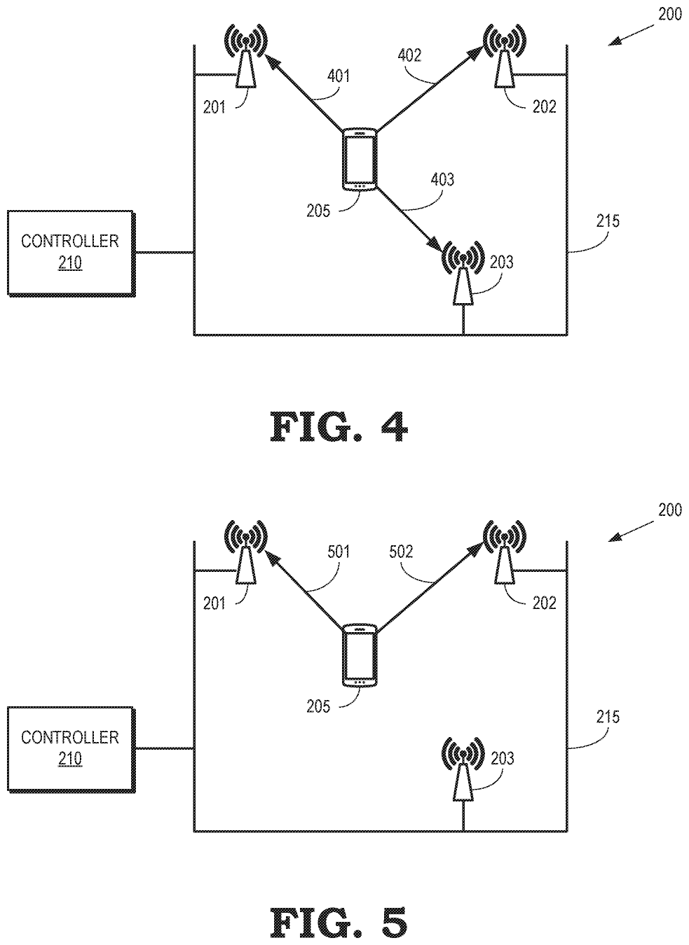

FIG. 4 is a block diagram of the communication system 200 during a second time interval that includes data transmission to acknowledge signals transmitted during the first time interval according to some embodiments. In the illustrated embodiment, the communication system 200 includes the access points 201-203, the user equipment 205, and the controller 210, which are interconnected by the backbone 215, as discussed with regard to FIG. 2. The user equipment 205 receives data in the frames transmitted by the access points 201, 203 in the first time interval, as illustrated in FIG. 2. The user equipment 205 processes the received data during the IFS concurrently with the access point 201 transmitting the sensing waveforms 301, 302, as illustrated in FIG. 3. The user equipment 205 is therefore prepared to transmit an acknowledgment signal at the beginning of the second time interval.

The access points 201-203 then switch from the transmit mode to the receive mode (or remain in the receive mode) during the second time interval. In some embodiments, the access points 201-203 autonomously switch to the receive mode (or remain in the receive mode) to prepare for reception of an acknowledgment message. In other embodiments, the controller 210 transmits signals that cause the access points 201-203 to switch from the transmit mode to the receive mode (or to remain in the receive mode) during the second time interval. The transition from the transmit mode to the receive mode takes place during a transition time interval at the beginning of the second time interval. Following the transition time interval, the user equipment 205 transmits an acknowledgment signal to the access points 201-203, as indicated by the arrows 401, 402, 403.

FIG. 5 is a block diagram of the communication system 200 including a user equipment 205 that is transmitting a sensing waveform during an IFS following the second time interval according to some embodiments. In the illustrated embodiment, the communication system 200 includes the access points 201-203, the user equipment 205, and the controller 210, which are interconnected by the backbone 215, as discussed with regard to FIG. 2. Transmission of sensing waveforms is bidirectional and so controller 210 can also instruct the user equipment 205 to transmit sensing waveforms that are received by one or more of the access points 201-203.

In the illustrated embodiment, the controller 210 transmits signals that cause the access points 201, 202 to switch from the transmit mode to a receive mode during the IFS. The transition from the transmit mode to the receive mode takes place during a transition time interval at the beginning of the IFS. Following the transition time interval, the user equipment 205 transmits a sensing waveform to the access points 201, 202, as indicated by the arrows 501, 502. The access points 201, 202 receive the sensing waveforms 501, 502 and provide information representative of the received sensing waveforms to the controller 210 via the backbone 215. As discussed herein, the information received by the controller 210 is used to generate information representative of the environment of the communication system 200.

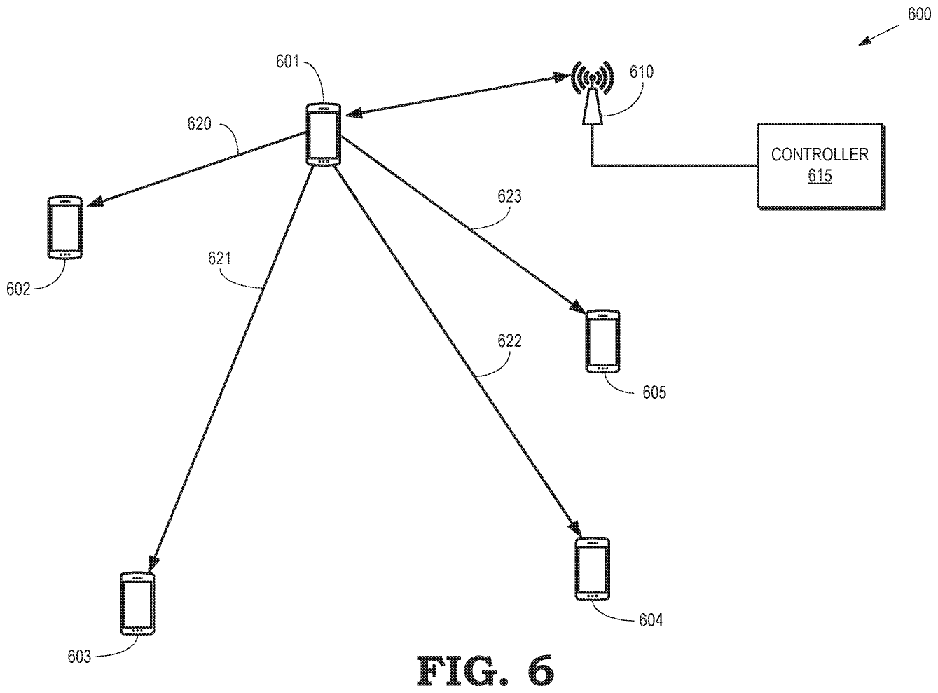

FIG. 6 is a block diagram of a communication system 600 that includes a mesh of user equipment 601, 602, 603, 604, 605 that perform radiofrequency sensing during an IFS according to some embodiments. The communication system 600 also includes one or more access points 610 and a controller 615. However, some embodiments of the communication system 600 are implemented without a central controller 615, e.g., using an opportunistic scheduler for mesh sensing by the user equipment 601-605. The communication system 600 is used to implement some embodiments of the communication system 100 shown in FIG. 1.

As discussed herein, data transmissions are performed using frames that are transmitted during corresponding time intervals, which are separated by IFS. For example, one or more of the user equipment 601-605 are scheduled for uplink transmissions to the access point 610 during a time interval for transmitting a frame. For another example, the access point 610 is scheduled for downlink transmissions towards one or more of the user equipment 601-605 during the time interval for transmitting the frame.

The controller 615 transmits signals instructing the user equipment 601 to transmit a sensing waveform during the IFS and instructing the user equipment 602-605 to receive the sensing waveform. Some embodiments of the controller 615 transmit the signals to the user equipment 601-605 via the access point 610. In response to receiving the instruction signals, the user equipment 601-605 transition to the appropriate transmit or receive mode during a transition time interval at the beginning of the IFS. The user equipment 601 then transmits the sensing waveform to the user equipment 602-605, as indicated by the arrows 620, 621, 622, 623, which are collectively referred to herein as “the sensing waveforms 620-623.” The user equipment 602-605 receive the sensing waveforms 620-623 and provide information representative of the received sensing waveforms 620-623 to the controller 615 for further processing, as discussed herein.

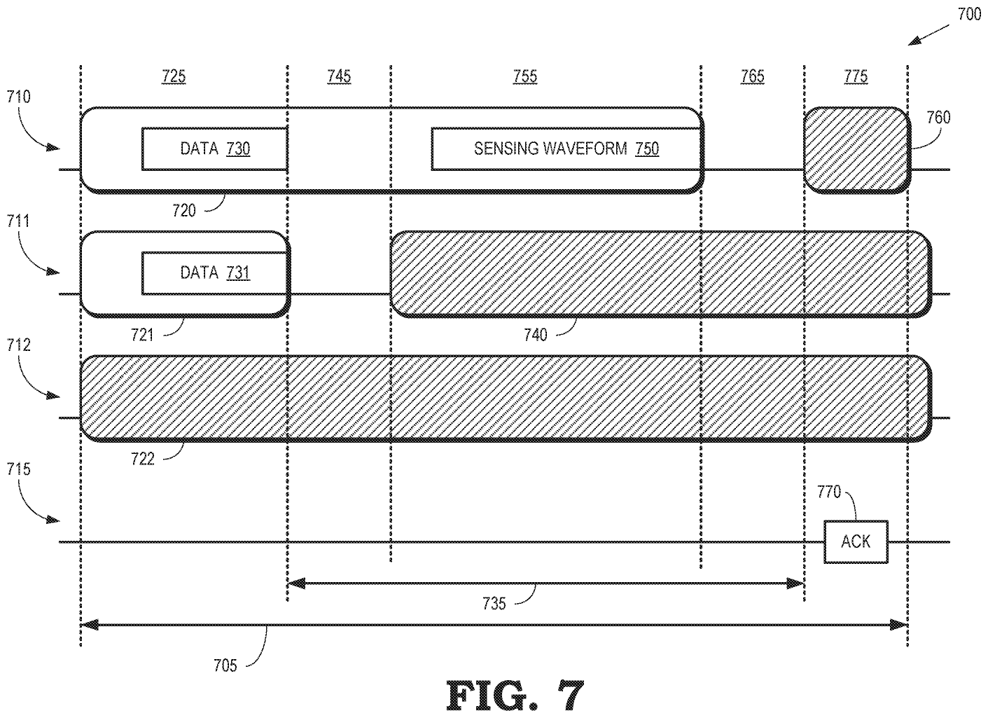

FIG. 7 is a timing diagram 700 illustrating transmit and receive modes for access points and user equipment according to some embodiments. The timing diagram 700 illustrates transmission and reception performed in some embodiments of the communication system 100 shown in FIG. 1, the communication system 200 shown in FIGS. 2-5, and the communication system 600 shown in FIG. 6. The timing diagram 700 shows time increasing from left to right during a transmission opportunity (TXOP) 705. The entities that transmit or receive during the TXOP 705 include access points 710, 711, 712 (collectively referred to herein as “the access points 710-712”) and the user equipment 715. Persons of ordinary skill in the art should appreciate that, in the interest of clarity, the time intervals shown in the timing diagram 700 are not drawn to scale. For example, data transmissions and acknowledgment messages are typically transmitted in time intervals that are thousands of times longer than an IFS time interval.

At the beginning of the illustrated TXOP 705, the access points 710, 711 are in a transmit mode, as indicated by the open blocks 720, 721, and the access point 712 is in a receive mode, as indicated by the crosshatched block 722. In the illustrated embodiment, the access points 710, 711 perform joint downlink transmission in a first time interval 725. For example, the access points 710, 711 jointly transmit copies of data in corresponding frames 730, 731, which are received by the user equipment 715.

A controller instructs the access point 710 to transmit a sensing waveform during an IFS 735. The controller also instructs the access points 711, 712 to receive the sensing waveform during the IFS 735. In response to receiving the instruction, the access point 711 switches from a transmit mode to a receive mode, as indicated by the crosshatched block 740. The access point 711 performs the switch during a transition time interval 745. The access point 712 is already in the receive mode and therefore does not switch modes during the transition time interval 745. In some embodiments, the IFS 735 has a duration of 16 μs, which is sufficient time to transmit one, two, or three OFDM symbols having durations of 4 μs. The small number of symbols that are transmitted for sensing purposes during the IFS 735 is not sufficient to transmit information bits. However, this is not a problem for radiofrequency sensing because the access points are coordinated (e.g., by a base station or controller) so that the source of the transmission and the receivers are known by the controller.

The access point 710 transmits a sensing waveform 750 during a sensing time interval 755 and the access points 711, 712 receive the sensing waveform 750 during the sensing time interval 755. The sensing waveforms received by the access points 711, 712 are used to perform sensing operations, as discussed herein.

At the end of the IFS 735, the access point 710 switches from the transmit mode to the receive mode, as indicated by the crosshatched block 760, during the transition time interval 765. The access points 711, 712 are already in the receive mode and do not switch modes during the transition time interval 765.

The user equipment 715 processes the data 730, 731 that is jointly transmitted by the access points 710, 711 during the IFS 735. At the end of the transition time interval 765, the user equipment 715 transmits an acknowledgment 770 that is generated based on the processed data 730, 731. The acknowledgment 770 is transmitted during an uplink acknowledgement time interval 775.

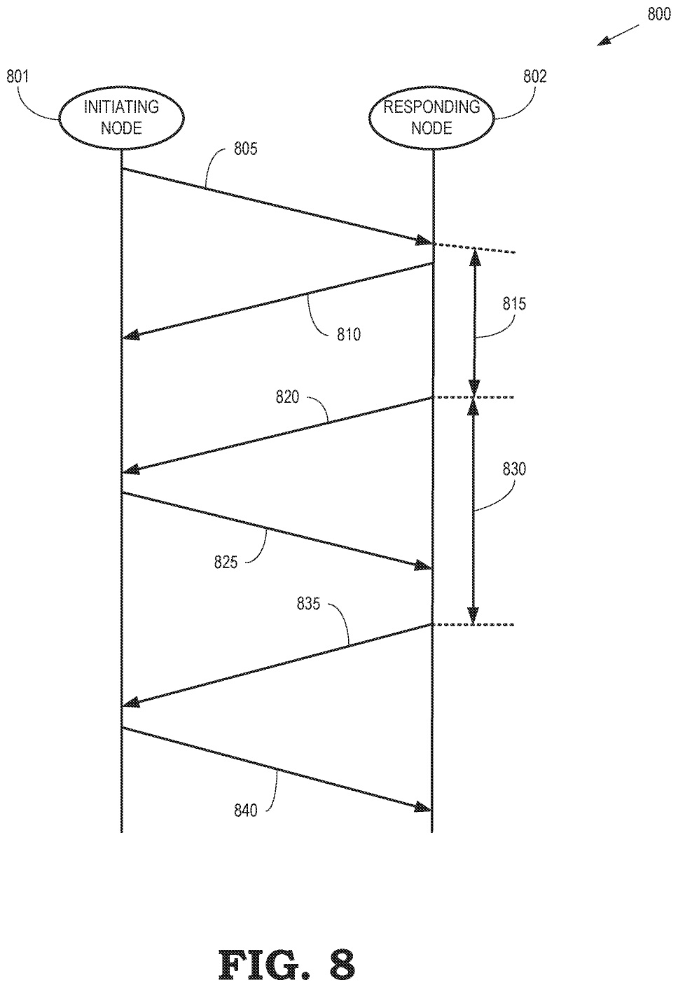

FIG. 8 illustrates a message exchange 800 that is used to determine a round trip time between an initiating node 801 and a responding node 802 according to some embodiments. Depending on the circumstances, the initiating node 801 can be an access point or a user equipment and the responding node 802 can be an access point or a user equipment. The message exchange 800 is implemented in some embodiments of the communication system 100 shown in FIG. 1, the communication system 200 shown in FIGS. 2-5, and the communication system 600 shown in FIG. 6.

The initiating node 801 transmits a measurement request 805 to the responding node 802, which responds with an acknowledgment 810. The responding node 802 waits for a predetermined time interval 815 (such as 10 ms or less) after reception of the measurement request 805 and then transmits a measurement message 820 at a transmission time, t₁. The measurement message 820 is received by the initiating node 801 at a reception time, t₂. In response to receiving the measurement message 820, the initiating node 801 transmits an acknowledgment message 825 at a transmission time, t₃. The acknowledgment message 825 is received by the responding node 802 at a reception time, t₄. The responding node 802 transmits a result message 830 after a predetermined time interval 835, such as 20 ms. Some embodiments of the result message 830 include information indicating the transmission time, t₁ and the reception time, t₄, e.g., in a couple of highly modulated symbols. In other embodiments, the result message 830 does not include timestamp information and the initiating node (or other entity) infers the transmission time, t₁ and the reception time, t₄, based on the timing of consecutive SIFS, transmission times, and reception times, as well as hardware delays. In response to receiving the result message 830, the initiating node 801 transmits an acknowledgment message 835.

The initiating node 801 (or another entity that receives timing information from the initiating node 801) calculates a round trip time (RTT) between the initiating node 801 and the responding node 802 based on the exchanged messages. In the illustrated embodiment, the RTT is calculated based on the transmission time, t₁, the reception time, t₂, the transmission time, t₃, and the reception time, t₄. For example, the RTT can be determined using the following:

$$R T T = \frac{( {t}_{4} - {t}_{1} ) - ( {t}_{3} - {t}_{2} )}{2}$$

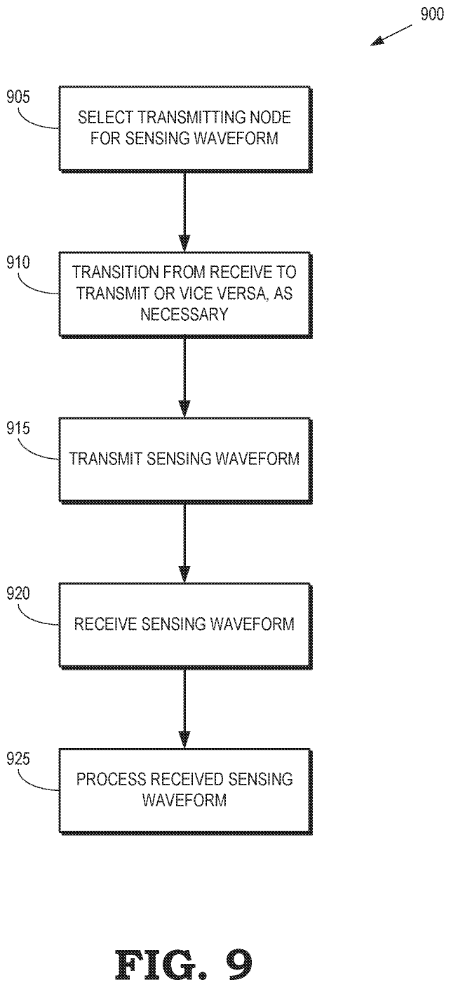

FIG. 9 is a flow diagram of a method 900 of performing radiofrequency sensing using sensing waveforms transmitted during an IFS according to some embodiments. The method 900 is implemented in some embodiments of the communication system 100 shown in FIG. 1, the communication system 200 shown in FIGS. 2-5, and the communication system 600 shown in FIG. 6.

At block 905, a transmitting node is selected to transmit the sensing waveform during the IFS. As discussed herein, the transmitting node can be an access point or a user equipment. Selection of the transmitting node is performed by a controller or a base station that coordinates operation of a set of wireless nodes including the access point and the user equipment. Instructions are then provided to the transmitting node and corresponding receiving nodes that are to receive the sensing waveform.

At block 910, the wireless nodes transition between the transmit mode and a receive mode. If necessary, the transmitting node transitions from the receive mode to the transmit mode during a transition time interval at the beginning of the IFS. If necessary, one or more of the receiving nodes transition from the transmit mode to the receive mode during the transition time interval.

At block 915, the transmitting node transmits the sensing waveform during the IFS. The sensing waveform is an OFDM signal, a W-Fi training sequence, a Zadoff Chu sequence, a Gold Code, or other signal type or format.

At block 920, the one or more receiving nodes receives the sensing waveform that is transmitted by the transmitting node. Information representative of the received sensing waveform is provided from the receiving nodes to a controller or base station, e.g., via a backbone network.

At block 925, the controller, base station, or other entity processes the information representative of the received sensing waveform. In some embodiments, processing of the received sensing waveform is used to determine presence of an object or person, a range of the object or person, an angle of the object or person, a velocity of the object or person, or other characteristics of the environment proximate the wireless nodes.

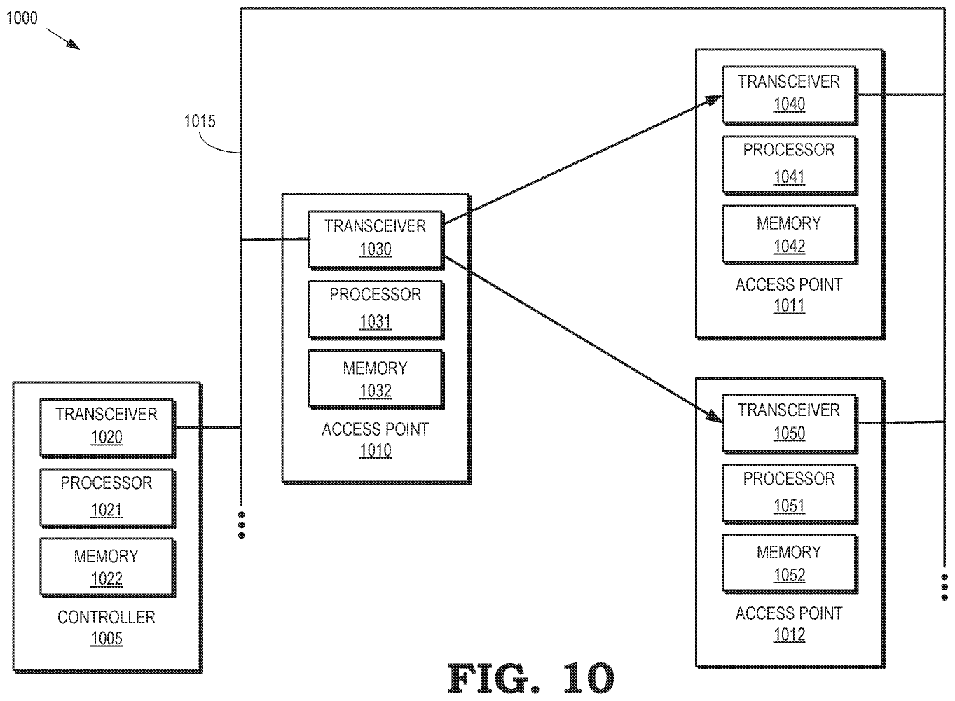

FIG. 10 is a block diagram of a communication system 1000 that supports radiofrequency sensing during IFS according to some embodiments. The communication system 1000 includes a controller 1005 and access points 1010, 1011, 1012, which are collectively referred to herein as “the access points 1010-1012.” The controller 1005 and the access points 1010-1012 are interconnected by a backbone 1015. The communication system 1000 therefore represents some embodiments of the communication system 100 shown in FIG. 1, the communication system 200 shown in FIGS. 2-5, and the communication system 600 shown in FIG. 6.

The controller 1005 includes a transceiver 1020 for transmitting and receiving signals, e.g. over the backbone 1015. The transceiver 1020 can be implemented as a single integrated circuit (e.g., using a single ASIC or FPGA) or as a system-on-a-chip (SOC) that includes different modules for implementing the functionality of the transceiver 1020. The controller 1005 also includes a processor 1021 and a memory 1022. The processor 1021 can be used to execute instructions stored in the memory 1022 and to store information in the memory 1022 such as the results of the executed instructions. The controller 1005 is therefore able to implement some embodiments of the timing diagram 700 shown in FIG. 7, the messaging sequence 800 shown in FIG. 8, and the method 900 shown in FIG. 9.

The access point 1010 includes a transceiver 1030 for transmitting and receiving signals, e.g. over the backbone 1015 or over an air interface. The transceiver 1030 can be implemented as a single integrated circuit (e.g., using a single ASIC or FPGA) or as a system-on-a-chip (SOC) that includes different modules for implementing the functionality of the transceiver 1030. The access point 1010 also includes a processor 1031 and a memory 1032. The processor 1031 can be used to execute instructions stored in the memory 1032 and to store information in the memory 1032 such as the results of the executed instructions. The access point 1010 is therefore able to implement some embodiments of the timing diagram 700 shown in FIG. 7, the messaging sequence 800 shown in FIG. 8, and the method 900 shown in FIG. 9.

The access point 1011 includes a transceiver 1040 for transmitting and receiving signals, e.g. over the backbone 1015 or over an air interface. The transceiver 1040 can be implemented as a single integrated circuit (e.g., using a single ASIC or FPGA) or as a system-on-a-chip (SOC) that includes different modules for implementing the functionality of the transceiver 1040. The access point 1011 also includes a processor 1041 and a memory 1042. The processor 1041 can be used to execute instructions stored in the memory 1042 and to store information in the memory 1042 such as the results of the executed instructions. The access point 1011 is therefore able to implement some embodiments of the timing diagram 700 shown in FIG. 7, the messaging sequence 800 shown in FIG. 8, and the method 900 shown in FIG. 9.

The access point 1012 includes a transceiver 1050 for transmitting and receiving signals, e.g. over the backbone 1015 or over an air interface. The transceiver 1050 can be implemented as a single integrated circuit (e.g., using a single ASIC or FPGA) or as a system-on-a-chip (SOC) that includes different modules for implementing the functionality of the transceiver 1050. The access point 1012 also includes a processor 1051 and a memory 1052. The processor 1051 can be used to execute instructions stored in the memory 1052 and to store information in the memory 1052 such as the results of the executed instructions. The access point 1012 is therefore able to implement some embodiments of the timing diagram 700 shown in FIG. 7, the messaging sequence 800 shown in FIG. 8, and the method 900 shown in FIG. 9.

In the illustrated embodiment, the controller 1005 has provided instructions to place the access point 1010 into a transmit mode to transmit sensing waveforms during an IFS, as indicated by the arrows 1060, 1065. The controller 1005 has also provided instructions to place the access points 1011, 1012 into a receive mode to receive the transmitted sensing waveforms 1060, 1065. The instructions are provided via the backbone 1015. The access points 1011, 1012 provide information representative of the received sensing waveforms to the controller 1005 via the backbone 1015.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

As used herein, the term “circuitry” may refer to one or more or all of the following:
(a) hardware-only circuit implementations (such as implementations and only analog and/or digital circuitry) and
(b) combinations of hardware circuits and software, such as (as applicable):
   (i) a combination of analog and/or digital hardware circuit(s) with software/firmware and
   (ii) any portions of a hardware processor(s) with software (including digital signal processor(s), software, and memory(ies) that work together to cause an apparatus, such as a mobile phone or server, to perform various functions) and
   (c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An apparatus comprising:
a transceiver configured to transmit during a first frame in a first time interval and during a second frame in a second time interval, wherein the first time interval and the second time interval are separated by an interframe space (IFS); and
a processor configured to generate a sensing waveform, wherein the transceiver is configured to transmit the sensing waveform during the IFS.

2. The apparatus of claim 1, wherein the IFS has a duration sufficient to receive a last symbol of the first frame, process the first frame, and respond with a first symbol of an earliest possible response frame.

3. The apparatus of claim 1, wherein the sensing waveform is at least one of an orthogonal frequency division multiplexing (OFDM) signal, a Wi-Fi training sequence, a Zadoff Chu sequence, or a Gold Code.

4. The apparatus of claim 1, wherein the transceiver is configured to transmit the sensing waveform after a transition time interval at the beginning of the IFS, wherein the transition time interval has a duration sufficient to allow the transceiver to transition from a transmit mode to a receive mode.

5. The apparatus of claim 1, wherein the transceiver is configured to:
transmit a request for a measurement signal from a wireless node;
receive, at a first reception time, the measurement signal from the wireless node in response to the request;
transmit, at a first transmission time, an acknowledgment signal in response to receiving the measurement signal; and
receive a result signal in response to the acknowledgment signal, wherein the result signal includes information indicative of a second transmission time of the measurement signal and a second reception time of the acknowledgment signal.

6. The apparatus of claim 1, wherein the processor is configured to determine a round-trip time between the apparatus and the wireless node based on the first reception time and the second reception time and the first transmission time and the second transmission time.

7. The apparatus of claim 1, wherein the transceiver is configured to transmit the sensing waveform during the IFS in response to instructions received from a controller.

8. The apparatus of claim 1, wherein the transceiver is configured to determine a transmission power for the sensing waveform based on topology information for other wireless nodes.

9. An apparatus comprising:
a transceiver configured to transmit during a first frame in a first time interval and during a second frame in a second time interval, wherein the first time interval and the second time interval are separated by an interframe space (IFS); and
a processor configured to switch the transceiver from a transmit mode during the first time interval to a receive mode during the IFS, wherein the transceiver is configured to receive a sensing waveform from a wireless node during the IFS.

10. The apparatus of claim 9, wherein the IFS has a duration sufficient to receive a last symbol of the first frame, process the first frame, and respond with a first symbol of an earliest possible response frame.

11. The apparatus of claim 9, wherein the sensing waveform is at least one of an orthogonal Frequency division multiplexing (OFDM) signal, a Wi-Fi training sequence, a Zadoff Chu sequence, or a Gold Code.

12. The apparatus of claim 9, wherein the transceiver is configured to switch from the transmit mode to the receive mode during a transition time interval at the beginning of the IFS.

13. The apparatus of claim 9, wherein the transceiver is configured to:
receive a request for a measurement signal from a wireless node;
transmit, at a transmission time, the measurement signal from the wireless node in response to the request;
receive, at a reception time, an acknowledgment signal in response to transmitting the measurement signal; and
transmit a result signal in response to the acknowledgment signal, wherein the result signal includes information indicative of the transmission time and the reception time.

14. The apparatus of claim 9, wherein the processor is configured to switch the transceiver from the transmit mode to the receive mode in response to instructions received from a controller.

15. The apparatus of claim 9, wherein the processor is configured to determine at least one of presence of an object or person, a range of the object or person, an angle of the object or person, or a velocity of the object or person.

16. The apparatus of claim 9, wherein the processor is configured to transmit information representative of the received sensing waveform to a controller, which uses the transmitted information to determine at least one of presence of an object or person, a range of the object or person, an angle of the object or person, or a velocity of the object or person.

17. An apparatus comprising:
a transceiver configured to exchange signals with a plurality of wireless nodes that are configured to transmit or receive in frames during time intervals, wherein the time intervals are separated by an interframe space (IFS), and
a processor configured to select a first subset of the plurality of wireless nodes to operate in a transmit mode during the IFS and a second subset of the plurality of wireless nodes to operate in a receive mode during the IFS, wherein the first subset transmits a sensing waveform during the IFS.

18. (canceled)

19. (canceled)

20. (canceled)

21. The apparatus of claim 17, wherein the transceiver is configured to instruct at least one of the plurality of wireless nodes to switch from a transmit mode to a receive mode or from a receive mode to a transmit mode.

22. The apparatus of claim 17, wherein the processor is configured to modify members of the first subset and the second subset in a subsequent IFS.

23. (canceled)

24. The apparatus of claim 17, wherein the processor is configured to interrupt transmission of the sensing waveform during the subsequent IFS.

25. (canceled)
